(19) United States
(12) Patent Application Publication
(10) Pub. No.: US 2015/0097364 A1
(43) Pub. Date: Apr. 9, 2015

(54) Hook and Loop Mechanism for Prevention of Fuel Tank Rotation

(71) Applicant: EcoDual, Inc., Beaufort, SC (US)

(72) Inventors: Patrick R. Moloney, Beaufort, SC (US); Douglas T. Thomson, Beaufort, SC (US)

(21) Appl. No.: 14/509,556

(22) Filed: Oct. 8, 2014

Related U.S. Application Data
(60) Provisional application No. 61/888,435, filed on Oct. 8, 2013.

(51) Int. Cl. B60K 15/07; B60K 15/03

(52) U.S. Cl. CPC B60K 15/07; B60K 15/03006
USPC 280/834; 29/525.03

(57) ABSTRACT

A system for securing a fuel tank to a mobile machine includes a mounting frame connectable to the mobile machine and having a substantially rigid portion configured to support the fuel tank, and a mounting strap connected to the mounting frame and configured to secure the fuel tank to the mounting frame by extending around at least a portion of an outer surface of the fuel tank. The system also includes a first connection material connected to at least one of the mounting frame and the mounting strap, and a second connection material configured to mesh with the first connection material thereby forming a removable hook-and-loop connection therewith. The second connection material is connectable to the outer surface of the fuel tank such that when the first connection material is meshed with the second material the removable connection therebetween substantially prohibits rotation of the fuel tank.

### CROSS-REFERENCE TO RELATED APPLICATIONS

This application claims the benefit of U.S. Provisional Patent Application No. 61/888,435, filed on Oct. 8, 2013, the entire disclosure of which is incorporated herein by reference.

### FIELD OF THE INVENTION

The present disclosure relates to fastening systems and, more particularly, to systems and methods of fastening fuel tanks to mobile machines.

### BACKGROUND

Fuel tanks used on mobile machines are commonly cylindrical in shape. Although many other shapes are available, the simplicity of fabrication of cylindrical tanks makes them typically the least expensive and thus most common in use. This is particularly true for larger mobile machines such as heavy trucks or other like vehicles. Heavy trucks commonly have large, cylindrical diesel fuel tanks mounted along the main structural frame rails of the vehicle. In common configurations, such large diesel tanks, often with a liquid fuel capacity of one hundred gallons or more, are attached to the mobile machine using a combination of a curved, substantially rigid mounting frame and a flexible mounting strap that constrains the tank about its circumference. Commonly two or three such “frame-and-strap” fastening systems are used to secure a single fuel tank.

Securing a cylindrical tank with known frame-and-strap fastening systems, while cost effective and convenient, can have difficulties preventing rotation of the tank. Rotation of cylindrical fuel tanks is a well-known issue in mobile machine operation. While the causes are not definitively known, it is generally accepted that the rotation results from some combination of forces from vehicle vibrations, vehicle frame flex, fuel movement, and/or other factors. These factors can result in very small incremental fuel tank movements that, in the aggregate, result in fuel tank rotation over time. Since liquid fuel tanks, such as diesel and gasoline fuel tanks, are filled from an opening at the top of the tank, it is undesirable to have the tanks rotate as that will reduce the tank capacity by preventing full fill. Such rotation can also damage fuel supply lines connected to the fuel tank and may cause additional damage to other components of the mobile machine.

The relatively recent introduction of pressurized gaseous fuel tanks has further highlighted the issue of fuel tank rotation. Natural gas, propane and other gaseous fuels require relatively thick-walled fuel tanks because these gases must be stored under pressure in order to achieve sufficient density and thus sufficient on-board fuel storage capacity. Cylindrical tanks are the most structurally-efficient pressure vessels and thus virtually all gaseous fuel tanks are cylinders. Tanks holding gaseous fuels are even more prone to rotation as the gaseous fuel tanks expand and contract throughout the pressurization cycle causing the mounting straps to loosen over time. It is understood that gaseous fuel tanks experience significant radial expansion and contraction under the high pressure cycling of filling and emptying. Thus, it becomes substantially more difficult to retain proper clamping force in the mounting straps. If, for any reason, the clamping force is momentarily lost and any gap is formed between the mounting strap and the fuel tank, the friction forces drop to zero and the tank can easily rotate in a ratcheting manner.

Numerous designs have been used in conjunction with known frame-and-strap systems an effort to minimize or prevent fuel tank rotation. Most such designs employ some form of compliant liner between the fuel tank and either the mounting frame or the mounting strap. This liner is typically formed from shaped rubber or a reinforced textile material. These designs exhibit varying degrees of success. However, such approaches suffer from the limitation that mounting strap loosening and varied mounting strap loading can lead to a reduction in surface contact between the liner and the outer surface of the tank, and thus, a loss of the frictional forces that are essential for preventing tank rotation with such designs.

In another often-used approach, the rubber material use to form the liner may be extruded so as to be flat on one side (adjacent to the mounting strap) and to have circumferential ridges on the other side (adjacent to the outer surface of the fuel tank). The intent of this approach is that the rubber material will be very slightly deformed and in contact when the tank is unpressurized. As pressure (and radial growth) increase, the material is much more free to deform than a regular flat rubber. Thus, friction may be maintained through a greater range of radial expansion. While potentially providing some improvement, tank rotation is known to still occur in installations that use this approach.

Additionally, a number of approaches have been used to better maintain mounting strap tension without the need for technicians checking mounting strap torque. In such approaches, the mounting strap tension is most commonly maintained by having a bolt extend from the end of the mounting strap, pass through a clearance hole in the mounting frame, and be secured to the mounting frame by a back-up nut. Torqueing down on the back-up nut puts tension on the mounting strap. However, this is a rigid system and prone to loss of tension. Thus, various spring mechanisms have been put in place between the back-up nut and the clearance hole structure to maintain tension through tank radial expansion. Some designs employ heavy duty die springs. Other designs employ Bellville washers. These approaches are sometimes used in conjunction with the specialty rubber materials. Again, as with the specialty rubber approach described above, some improvements may be achieved but tank rotation is known to still occur.

In still further approaches, a “key and slot” configuration has been employed in which a rigid key has been welded or otherwise connected to the outer surface of the fuel tank. While this approach may be possible with unpressurized liquid fuel tanks, it is largely frowned upon in the industry because fuel tank fabricators want the benefit of universal applicability regardless of the manufacturer of the mobile machine. In particular, specialty rigid keying would create significant supply and cost issues, and as a result, this approach has not been embraced by liquid fuel tank manufacturers or users.

Moreover, adding a rigid key to a composite pressure vessel, such as the gaseous fuel tanks described above, is not a viable structural solution without major design and cost impact. Further, attempts have been made to employ an applique keyed material to assist in minimizing rotation of pressurized gaseous fuel tanks. In one approach, keyed rubber material with transverse and/or circumferential ridges may be adhered to both the outer surface of the fuel tank and the mounting strap (or mounting frame). During tank installation, these keyed surfaces are matched up and interlocked to prevent rotation. This approach initially suffers from difficulty of installation because the registration of the two materials relative to each other must be perfect. Beyond that, it suffers from the same issue facing all flexible liner approaches, loss of tension in the straps. When tension is lost, the two mating materials can pull apart from each other and disengage. This is because there is no tensile strength between the materials in the assembly.

The various embodiments of the present disclosure are directed toward solving one or more of the problems described above.

### SUMMARY

In an exemplary embodiment of the present disclosure, a system for securing a fuel tank to a mobile machine includes a mounting frame connectable to the mobile machine and having a substantially rigid portion configured to support the fuel tank, and a mounting strap connected to the mounting frame and configured to secure the fuel tank to the mounting frame by extending around at least a portion of an outer surface of the fuel tank. The system also includes a first connection material connected to at least one of the mounting frame and the mounting strap, and a second connection material configured to mesh with the first connection material thereby forming a removable hook-and-loop connection therewith. The second connection material is connectable to the outer surface of the fuel tank such that when the first connection material is meshed with the second material the removable connection therebetween substantially prohibits rotation of the fuel tank.

In another exemplary embodiment of the present disclosure, a system for securing a fuel tank to a mobile machine includes a mounting frame connectable to the mobile machine and having a substantially rigid portion configured to support the fuel tank. The system also includes a mounting strap having a first end removably connectable to the mounting frame and a second end fixedly connected to the mounting frame. The mounting strap is configured to extend around at least a portion of an outer surface of the fuel tank when the fuel tank is supported by the mounting frame and to secure the fuel tank to the mounting frame when the first end is removably connected to the mounting frame. The system also includes a first connection material connected to at least one of the mounting frame and the mounting strap, and a second connection material configured to mesh with the first connection material thereby forming a removable hook-and-loop connection therewith. The second connection material is connectable to the outer surface of the fuel tank such that when the first connection material is meshed with the second material the removable connection therebetween substantially prohibits rotation of the fuel tank about a longitudinal axis of the tank and translation of the tank along the longitudinal axis.

In a further exemplary embodiment of the present disclosure, a method of securing a fuel tank to a mobile machine includes disposing the fuel tank adjacent to a mounting frame connected to the mobile machine such that a first portion of an outer surface of the fuel tank abuts a corresponding curved portion of the mounting frame. The method also includes extending a mounting strap connected to the mounting frame about a second portion of the outer surface, and removably connecting a first end of the mounting strap to the mounting frame to secure the fuel tank to the mounting frame. The method further includes forming a removable hook-and-loop connection between a first connection material connected to at least one of the mounting frame and the mounting strap, and a second connection material connected to the outer surface of the fuel tank. In such an exemplary method, the removable connection substantially prohibits rotation of the fuel tank.

### BRIEF DESCRIPTION OF THE DRAWINGS

FIG. 1 illustrates a fuel tank fastened to a mobile machine using an exemplary fastening system of the present disclosure.

FIG. 2 further illustrates the exemplary fastening system shown in FIG. 1.

FIG. 3 is a partial exploded view of the fastening system shown in FIG. 1.

### DETAILED DESCRIPTION OF THE DRAWINGS

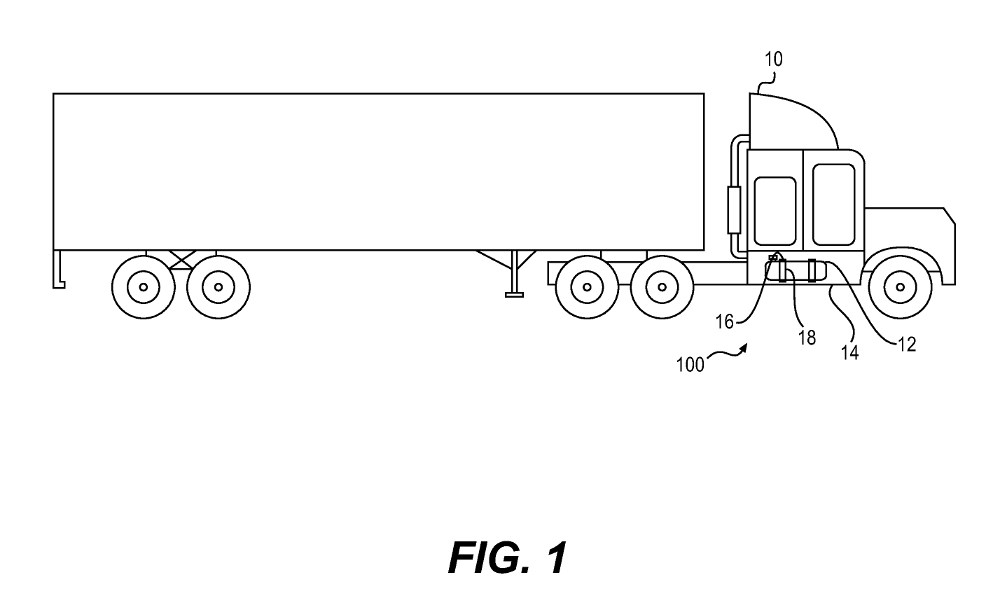

FIG. 1 illustrates a fastening system 100 associated with a mobile machine 10 according to an exemplary embodiment of the present disclosure. Such an exemplary fastening system 100 may be configured to minimize and/or otherwise substantially prohibit rotation of a variety of components typically carried by the mobile machine 10. Such a fastening system 100 may also be configured to minimize and/or substantially prohibit translation of such components in one or more directions, such as along one or more axes. As will be described in greater detail below, such components may include, among other things, a fuel tank 12, or other like component of the mobile machine 10.

In exemplary embodiments, the mobile machine 10 may be any type moving vehicle known in the art. Such moving vehicles may include, for example, over the road vehicles, off-road vehicles, and the like. For example, such mobile machines 10 may embody light-duty trucks, heavy duty trucks, wheel loaders, graders, and other like vehicles used in mining, construction, agriculture, transportation, and/or other like applications. Such mobile machines 10 may be powered by an engine (not shown) configured to combust a single fuel such as diesel, gasoline, natural gas, and the like. Alternatively, the engine may be configured to combust a mixture or combination of fuels as desired. In such embodiments, the one or more fuels may be carried by the mobile machine 10, and may be stored in one or more fuel tanks 12 connected to a frame 14 of the mobile machine 10. While FIG. 1 illustrates the fuel tank 12 being disposed on a side of the frame 14, such as on a frame rail or other like structure, in further exemplary embodiments, the fuel tank 12 may be disposed at various other locations on the mobile machine 10 such as beneath the frame 14, or substantially within (i.e., internal to or substantially surrounded by) the frame 14. Regardless of its position relative to the frame 14, the fuel tank 12 may be removably connected to the frame 14 via one or more mounting frames 16 and one or more mounting straps 18 of the fastening system 100.

In exemplary embodiments, the fuel tank 12 may comprise any substantially hollow container known in the art configured to store, safely transport, and controllably dispense a fluid substance disposed therein. For example, the fuel tank 12 may be configured to carry liquid or gaseous fuels therein and to controllably dispense such fuels in response to operation of one or more fuel pumps, fuel rails, fuel injectors, and/or other like fuel system components (not shown) fluidly connecting the fuel tank 12 to the engine. To facilitate storage and/or dispensing of such fuels, the fuel tank 12 may be substantially cylindrical in shape as is known in the art. Additionally, the fuel tank 12 may be configured to store any volume of such fuels sufficient to facilitate a desired range of travel of the mobile machine 10. In exemplary embodiments, the fuel tank 12 may be configured to store, for example, upwards of 100 gallons of liquid fuel, and in other exemplary embodiments, the fuel tank 12 may be configured to store and analogous volume of gaseous fuels, such as natural gas, at an elevated pressure.

In exemplary embodiments in which the engine of the mobile machine 10 is configured operate on and/or combust liquid fuels, various aspects of the fuel tank 12 may be tailored to handle such liquid fuels. For example, in such embodiments the fuel tank 12 may be made from aluminum, steel, and/or other like metals or alloys. Such materials may be substantially noncorrosive and may also be relatively lightweight to assist in maximizing the fuel efficiency of the mobile machine 10. Additionally, since such liquid fuels need not be stored at elevated pressures, the top, bottom, sidewalls, and/or other components of the fuel tank 12 may have a relatively standard wall thickness.

Alternatively, in exemplary embodiments in which the engine of the mobile machine 10 is configured to operate on and/or combust gaseous fuels and/or a combination or mixture of liquid and gaseous fuels, the fuel tank 12 may be tailored to handle such gaseous fuels. For example, in such embodiments the fuel tank 12 may be made from one or more of the metals and/or alloys described above, and the top, bottom, sidewalls, and/or other components of the fuel tank 12 may be characterized by a relatively greater wall thickness than a corresponding wall thicknesses of an analogous liquid fuel tank 12. Additionally, fuel tanks 12 configured to handle gaseous fuels may include a fiberglass, carbon fiber, and/or other like composite layer that is overlaid on top of one or more components of the fuel tank 12. For example, such a composite layer may be formed on, surround, and/or otherwise substantially enclose the metal and/or alloy walls of an exemplary gaseous fuel tank 12. Such a composite layer may improve the capability of the fuel tank 12 to store, safely transport, and/or dispense fuels at elevated pressures, and in exemplary embodiments, such pressures may exceed approximately 500 psi. For example, some exemplary gaseous fuel tanks 12 may be configured to store, safely transport, and/or dispense fuels at internal tank pressures greater than approximately 3500 psi. Regardless of its configuration, the fuel tank 12 may include one or more ports and/or other like components configured to facilitate filling of the fuel tank 12 with an appropriate fuel. The fuel tank 12 may further include one or more additional ports configured to facilitate a fluid connection between, for example, the fuel tank 12 and one or more of the fuel pumps and/or other like fuel system components (not shown) described above.

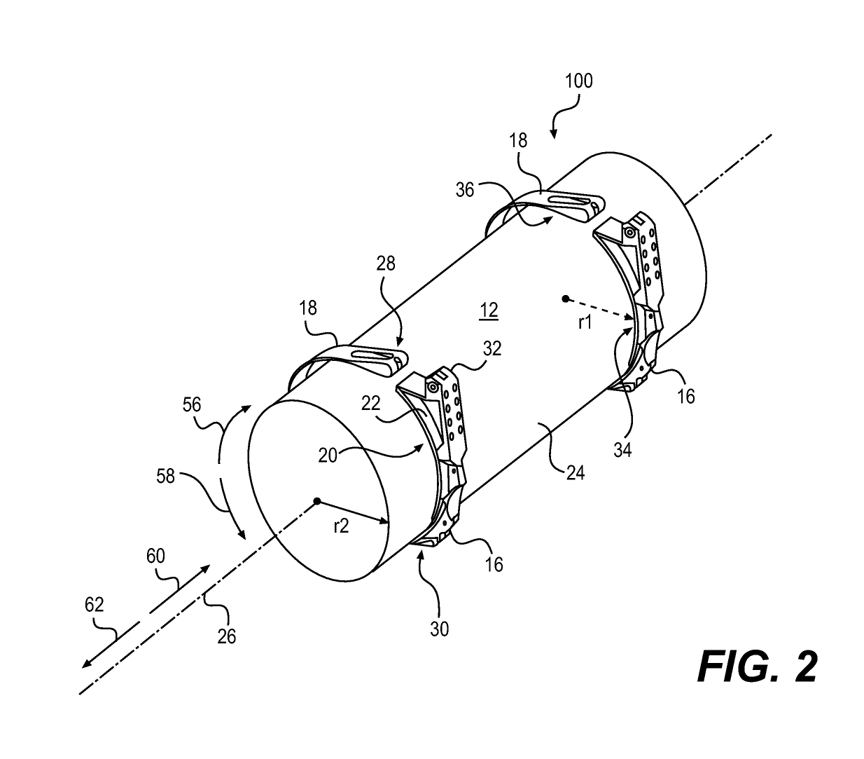

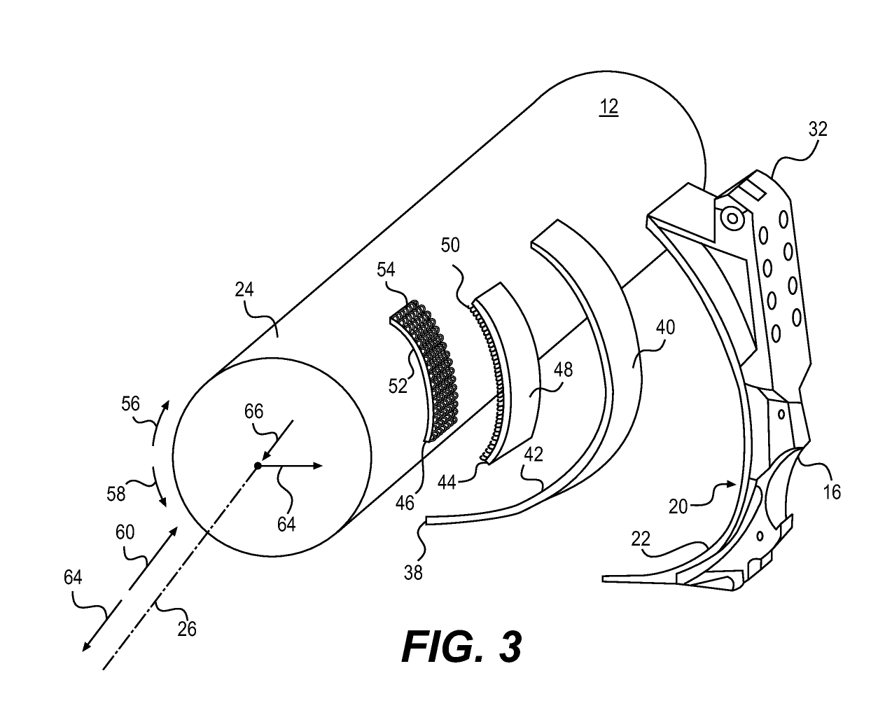

As shown in FIG. 1, and as noted above, the fastening system 100 may be configured to removably secure the fuel tank 12 to the frame 14 of the mobile machine 10 in a variety of locations or configurations. To facilitate this, the mounting frame 16 may be connectable to the mobile machine 10 at any desired location, such as along the frame 14. As shown in greater detail in FIGS. 2 and 3, the mounting frame 16 may include one or more substantially rigid portions 20 configured to support the fuel tank 14. For example, the substantially rigid portion 20 of the mounting frame 16 may be configured to support the fuel tank 12 while the fuel tank 12 is filled to capacity with liquid or gaseous fuel. To facilitate supporting the fuel tank 12, the mounting frame 16 may also include, for example, a curved portion 22 that is shaped, sized, positioned, and/or otherwise configured to assist in securing the fuel tank 12 to the mounting frame 16. In any of the exemplary embodiments described herein, the substantially rigid portion 20 may include the curved portion 22.

Further, it is understood that portions of the mounting frame 16, such as the substantially rigid portion 20 and/or the curved portion 22 may be formed from any of a variety of metals, alloys, castings, or other rigid materials known in the art. Such materials may include, for example, any of a variety of steels or steel castings. The mounting frame 16 may include one or more thru holes or other like components configured to facilitate connecting the mounting frame 16 to, for example, the frame 14 of the mobile machine 10. Alternatively, and/or in addition, the mounting frame 16 may include one or more shoulders, flanges, tabs, or other like structures configured to facilitate a welded connection between the mounting frame 16 and the frame 14.

In exemplary embodiments, the curved portion 22 may be substantially L-shaped, substantially J-shaped, substantially C-shaped, and/or otherwise rounded or curved. In exemplary embodiments, such a curved portion 22 may extend substantially beneath at least a portion of the fuel tank 12 to facilitate supporting the fuel tank 12 on the mounting frame 16. For example, in an exemplary curved portion 22 of the mounting frame 16 may include any desired radius of curvature r₁ to facilitate supporting the fuel tank 12. In such embodiments, the fuel tank 12 may include a corresponding radius of curvature r₂ that is formed and/or otherwise defined by an outer surface 24 of the fuel tank 12. In such embodiments, the curved portion 22 of the mounting frame 16 may include a radius of curvature r₁ that is substantially equal to the radius of curvature r₂ of the outer surface 24 of the fuel tank 12. In still further exemplary embodiments, the curved portion 22 of the mounting frame 16 may be omitted, and in such embodiments, the substantially rigid portion 20 of the mounting frame 16 may be substantially flat.

As shown in FIG. 2, the mounting strap 18 may be connected to the mounting frame 16, and may be configured to secure the fuel tank 12 to the mounting frame 16 by extending around at least a portion of the outer surface 24 of the fuel tank 12. In exemplary embodiments, the mounting strap 18 may be made from any substantially flexible weight-bearing material known in the art configured to support the weight of the fuel tank 12 when the fuel tank 12 is substantially completely filled with fuel. For example, the mounting strap 18 may be made from any of the metals, alloys, and/or other materials described above with respect to the fuel tank 12. In such embodiments, the mounting strap 18 may comprise a substantially flexible metal belt, band, strip, and/or other like structure configured to surround substantially the entire outer surface 24 of the fuel tank 12 and to provide a retaining force sufficient to keep the fuel tank 12 secured to the mounting frame 16 during, for example, movement of the mobile machine 10 to which the mounting frame 16 is connected.

In exemplary embodiments, a first end 28 of the mounting strap 18 may be removably connectable to the mounting frame 16, and a second end 30 of the mounting strap 18 may be fixedly connected to the mounting frame 16. For example, the second end 30 of the mounting strap 16 may be welded, bolted, pinned, and/or otherwise connected to the mounting frame 16. In such a configuration, the mounting frame 16 and/or the second end 30 of the mounting strap 18 may include one or more pins, bolts, and/or other known connection components (not shown) configured to facilitate such a connection.

Additionally, at least one of the mounting frame 16 and the first end 28 of the mounting strap 18 may include a winch mechanism 32. The winch mechanism 32 may be configured to assist in releasably and/or otherwise removably connecting the first end 28 of the mounting strap 18 to the mounting frame 16. For example, the winch mechanism 32 may include one or more spring-loaded turn keys, bolts, ratchet nuts, and/or other like components. Such components of the winch mechanism 32 may be configured to assist in tightening the mounting strap 18 around the outer surface 24 of the fuel tank 12. Tightening the mounting strap 18 in this way may pull the fuel tank 12 into intimate contact with the mounting frame 16, and/or components thereof, and may increase the retention force applied to the fuel tank 12 by the mounting strap 18. For example, when the first end 28 of the mounting strap 18 is connected to the mounting frame 16, a first portion 34 of the outer surface 24 may abut the curved portion 22 of the mounting frame 16 while the mounting strap 18 extends around a second portion 36 of the outer surface 24.

In exemplary embodiments, the mounting strap 18 may include one or more slots, thru holes, teeth, ridges, tabs, shoulders, and/or other like components configured to assist in tightening the mounting strap 18 about the fuel tank 12 by way of the winch mechanism 32. It is understood that in further exemplary embodiments, the winch mechanism 32 may be omitted. In such embodiments, one or more screws, bolts, or other like connection devices may be employed in place of the winch mechanism 32 to assist in tightening the mounting strap 18 around the outer surface 24 of the fuel tank 12. Regardless of whether the winch mechanism 32 or other like connection devices are employed by the fastening system 100, it is understood that such winch mechanisms 32 or connection devices may also be configured to controllably loosen and release the first end 28 of the mounting strap 18 from the mounting frame 16 to facilitate removal of the fuel tank 12 for servicing. It is further understood that the mounting strap 18 has been omitted from FIG. 3 for clarity.

As shown in at least FIG. 3, the fastening system 100 may also include a first connection material 44 and a second connection material 46 configured to mate and/or otherwise mesh with the first connection material 44. The first and second connection materials 44, 46 may have any known configuration enabling and/or otherwise providing for a releasable and/or otherwise removable connection between the first connection material 44 and the second connection material 46. For example, the second connection material 46 may be configured to mate and/or otherwise mesh with the first connection material 44, thereby forming a removable “hook-and-loop” connection and/or any other substantially rigid releasable connection therewith. In such a removable connection, a portion and/or various components of the first connection material 44 may become entwined, entangled, embedded, meshed, nested, interwoven, and/or otherwise intimately engaged with a corresponding portion and/or corresponding components of the second connection material 46. In such embodiments, the intimate engagement between the first and second connection material 44, 46 may assist in forming such a removable connection.

In an exemplary embodiment, the first connection material 44 may include a base 48. The base 48 may be substantially planar, substantially flexible, and may be configured to mate with one or more components of the fastening system 100. For example, the base 48 may be adhered and/or otherwise connected to the outer surface 24 of the fuel tank 12, the substantially rigid portion 20 of the mounting frame 16, and/or other components of the fastening system 100. The first connection material 44 may further include a plurality of hooks 50 and/or other like connection features known in the art. As shown in FIG. 3, such hooks 50 may extend substantially perpendicularly from the base 48. In such embodiments, the hooks 50 may project outwardly from the base 48 to facilitate forming a removable connection with the second connection material 46. The base 48 and/or the hooks 50 may be made from one or more plastics, polymers, and/or other like synthetic materials. In such embodiments, the base 48 and/or the hooks 50 may be formed via injection molding and/or other known synthetic material formation processes.

Similar to the first connection material 44, the second connection material 46 may include a base 52 that is substantially planar, substantially flexible, and that is configured to mate with one or more components of the fastening system 100. For example, the base 52 may be adhered and/or otherwise connected to the outer surface 24 the fuel tank 12, the substantially rigid portion 20 of the mounting frame 16, and/or other components of the fastening system 100. It is understood that while the second connection material 46 is illustrated in FIG. 3 as being connected to the outer surface 24 of the fuel tank 12, in alternative exemplary embodiments, the position and/or orientation of the first and second connection materials 44, 46 may be reversed such that the first connection material 44 is connected to the outer surface 24. Further, although single pieces of the first and second connection material 44, 46 are illustrated in FIG. 3, in further embodiments, multiple pieces of first and second connection material 44, 46 may be used in the fastening system 100. In such embodiments, the locations of each respective piece of first connection material 44 may substantially correspond to the locations of each corresponding respective piece of second connection material 46. In still further embodiments, for ease of use, at least one of the first and second connection materials 44, 46 may be positioned, disposed, connected, sized, shaped, and/or otherwise configured such that it extends around substantially an entire circumference of the outer surface 24 of the fuel tank 12.

The second connection material 46 may further include a synthetic mesh 54. In exemplary embodiments, the synthetic mesh 54 may be molded, woven, and/or otherwise formed on the base 52. In such embodiments, the base 52 and/or the synthetic mesh 54 may be made from any of the plastics, polymers, and/or other materials described above with respect to the first connection material 44. Further, the synthetic mesh 54 may be sufficiently dense to allow one or more of the synthetic hooks 50 to nest therein and be retained thereby once sufficient pressure is applied to join the first and second connection materials 44, 46. Thus, the removable hook-and-loop connection described above may be formed between the first and second connection material 44, 46 when, for example, a plurality of the hooks 50 have become nested within the synthetic mesh 54 so as to be retained by the synthetic mesh 54. In exemplary embodiments, the first and second connection materials 44, 46 may resemble Velcro® or other like connection materials configured to form similar removable connections.

In exemplary embodiments, one of the first connection material 44 and the second connection material 46 may be adhered and/or otherwise connected to at least one of the mounting frame 16 and the mounting strap 18. In such embodiments, the other of the first connection material 44 and the second connection material 46 may be connectable to the outer surface 24 of the fuel tank 12 such that when the first connection material 44 is meshed with the second connection material 46, the removable connection formed their between substantially prohibits rotation of the fuel tank 12. For example, the fuel tank 12 may include a longitudinal axis 26 extending substantially centrally therethrough. In such embodiments, the removable connection between the first and second connection materials 44, 46 may substantially prohibit rotation of the fuel tank 12 about the longitudinal axis 26 in the clockwise direction of arrow 56 and in the counterclockwise direction of arrow 58. Such a removable connection may also substantially prohibit translation of the fuel tank 12 along the longitudinal axis 26. For example, such a removable connection may substantially prohibit translation of the fuel tank 12 in the rearward direction of arrow 60, in the forward direction of arrow 62, and/or in any other like direction substantially parallel to or at an angle relative to the longitudinal axis 26.

In exemplary embodiments, the removable connection formed between the first connection material 44 and the second connection material 46 may be characterized by any tensile and/or shear strength known in the art. Such tensile and/or shear strengths may be individual metrics indicative of, for example, the strength of the removable connection formed between the first and second connection materials 44, 46. With reference to FIG. 3, an exemplary shear strength may act to resist relative movement between the first connection material 44 and the second connection material 46 in the direction of one or more of arrows 56, 58, 60, 62. Moreover, an exemplary tensile strength may act to resist relative movement between the first and second connection materials 44, 46 in the direction of arrows 64, 66 substantially transverse to the longitudinal axis 26. For example, the removable connection described herein may be characterized by a tensile strength sufficient to resist movement of the first connection material 44 away from the second connection material 46 in the direction of arrow 64. Alternatively, the removable connection described herein may be characterized by a tensile strength sufficient to resist movement of the second connection material 46 away from the first connection material 44 in the direction of arrow 66. In exemplary embodiments, the removable connection formed between the first and second connection materials 44, 46 may be characterized by a tensile strength of greater than approximately 20 psi and a shear strength of greater than approximately 100 psi. In further exemplary embodiments, the tensile strength of the removable connection may be greater than or less than approximately 20 psi and the shear strength may be greater than or less than approximately 100 psi to assist in substantially prohibiting rotation and/or translation of the fuel tank 12.

In further exemplary embodiments, the tensile strength and/or the shear strength described herein with respect to the removable connection between the first and second connection materials newer 44, 46 may increase or decrease during use and/or otherwise over time. For example, the tensile strength and/or the shear strength may increase in response to vibrational movement of the fuel tank 12 while the fuel tank 12 is secured to the mounting frame 16. Such vibrational movement may result from, among other things, movement of the mobile machine 10 while the fuel tank 12 is secured to the mounting frame 16 via the mounting strap 18. In particular, such vibrational movement may cause one or more of the synthetic hooks 52 become further meshed, nested, and/or otherwise embedded within the synthetic mesh 54 of the second connection material 46. Accordingly, such vibrational movement may increase a retention force associated with the removable connection formed between the first and second connection materials 44, 46. Further, in exemplary embodiments the removable connection formed between the first and second connection materials 44, 46 may be characterized by at least one of the tensile strength and a shear strength that is great enough to secure the fuel tank 12 to the mounting frame 16 while the first end 28 of the mounting strap 18 is disconnected from the mounting frame 16.

As illustrated in at least FIG. 3, in exemplary embodiments the fastening system 100 may further include one or more liners 38. For example, the fastening system 100 may include a single substantially annular flexible liner 38 substantially surrounding the outer surface 24 of the fuel tank 12. Alternatively, the fastening system 100 may include one or more substantially planar flexible liners 38 disposed at various locations around the outer surface 24. In exemplary embodiments, one or more liners 38 may be disposed between the outer surface 24 and at least one of the mounting frame 16 and the mounting strap 18. For example, a liner 38 may be disposed between the first connection material 44 and at least one of the mounting frame 16 and the mounting strap 18. As noted above, the mounting strap 18 has been omitted from FIG. 3 for clarity.

The liner 38 may be made from any substantially flexible substantially wear-resistant material known in the art. Such materials may include, for example, rubber, plastic, polymers, synthetic materials, or other like materials having a durometer or other like characteristics configured to facilitate protection of the fuel tank 12 during use. For example, the liner 38 may be configured to prevent damage to the outer surface 24 of the fuel tank 12 caused by, for example, the retention force applied thereto by the mounting strap 18 and/or the mounting frame 16. The liner 38 may have any length, width, thickness, or other configuration to assist in preventing damage to the fuel tank 12.

In exemplary embodiments, the liner 38 may include a first side 40 and a second side 42 opposite the first side 40. In such embodiments, the first side 40 may be adhered and/or otherwise fixedly connected to at least one of the mounting frame 16 and the mounting strap 18. In such embodiments, the second side 42 may be adhered and/or otherwise fixedly connected to the first connection material 48. For example, the second side 42 of the liner 38 may be fixedly connected to the base 48 of the first connection material 44. Alternatively, in exemplary embodiments in which the base 48 of the first connection material 44 is connected to the outer surface 24 of the fuel tank 12, the second side 42 of the liner 38 may be adhered an/or otherwise fixedly connected to the base 52 of the second connection material 46.

In exemplary embodiments, the fastening system 100 may be utilized to secure the fuel tank 12 to the mobile machine 10 for use in a variety of different applications. In such embodiments, the fuel tank 12 may be disposed adjacent to the mounting frame 16 connected to the mobile machine 10 such that the first portion 34 of the outer surface 24 of the fuel tank 12 abuts the substantially rigid portion 20 and/or the curved portion 22 of the mounting frame 16. With the fuel tank 12 so disposed, the mounting strap 18 connected to the mounting frame 16 may be extended about the outer surface 24, such as about the second portion 36 of the outer surface 24. In such embodiments, the first end 28 of the mounting strap 18 may be releasably, removably, and/or otherwise connected to the mounting frame 16 in order to secure the fuel tank 12 to the mounting frame 16. In exemplary embodiments, the winch mechanism 32 may be utilized to connect the first end 28 to the mounting frame 16 and/or to tighten the mounting strap 18 about the outer surface 24. Additionally, a removable hook-and-loop connection may be formed between a first connection material 44 connected to at least one of the mounting frame 16 and the mounting strap 18, and a second connection material 46 connected to the outer surface 24 of the fuel tank 12. It is understood that one or more pieces and/or individual strips of cooperating first and second connection material 44, 46 may be utilized in exemplary embodiments of the present disclosure. In such embodiments, one or more corresponding removable connections may be formed therebetween. Moreover, the removable connection formed between the first and second connection materials 44, 46 may substantially prohibit rotation and/or translation of the fuel tank 12 as described above.

In an exemplary method of securing the fuel tank 12 to the mounting frame 16, a relatively thin sheet of flexible plastic, flexible aluminum, flexible steel, or other like substantially flexible material may be disposed adjacent to the mounting frame 16, such as adjacent to one of the first and second connection materials 44, 46 disposed on the mounting frame 16, prior to disposing the fuel tank 12 thereon. For example, the sheet of material may be disposed between the first and second connection materials 44, 46 when the fuel tank 12 is initially positioned on the mounting frame 16, and the sheet of material may substantially prevent formation of the removable connection between the first and second materials 44, 46. Without such a removable connection being formed, the fuel tank 12 may be radially positioned (e.g., in the direction of arrows 56, 58) and/or axially positioned (e.g., in the direction of arrows 60, 62) relative to the mounting frame 16 with relative ease. Once the fuel tank 12 is desirably positioned relative to the mounting frame 16, the mounting strap 18 may be at least partially tightened about the outer surface 24 of the fuel tank 12 in order to at least partially immobilize the fuel tank 12. The sheet of material may then be removed by pulling and/or sliding the sheet of material out from between the first and second connection materials 44, 46. Once the sheet of material has been removed, the weight of the fuel tank 12 and/or the force being applied by the mounting strap 18 may assist in forming the removable connection between the first and second connection materials 44, 46. It is understood that the sheet of material may extend at least partially around the outer circumference of the fuel tank 12 and, in some embodiments, the sheet of material may be temporarily taped, adhered, and/or otherwise fixed thereto prior to installing the fuel tank 12. Regardless of its shape, size, and/or configuration, the sheet of material may temporarily interfere with the formation of the removable connection between the first and second connection materials 44, 46 for the purpose of properly positioning the fuel tank 12 relative to the mounting frame 16.

The exemplary fastening systems 100 described herein provide many advantages over existing systems. For example, known fastening systems are prone to loosening over time due to the shock and vibration forces of normal vehicle operation. Once such systems become loose, damage to the various system component can occur. In particular, such loosening can cause attachment strap stretching, wear of rubber liners, damage to the fuel tank, fluid leaks at the various connections between the fuel tank and other fuel system components, as well as other undesirable effects. In addition, such loosening enables rotation of the fuel tank due to the reduction and/or loss of friction between the outer surface of the fuel tank and the various retention components of such systems.

On the other hand, the removable connections formed by the exemplary fastening systems 100 of the present disclosure are characterized by a shear strength sufficient to prevent fuel tank rotation. These removable connections are also characterized by a tensile strength sufficient to keep the fuel tank 12 tightly held against the mounting frame 16 and thus unable to rotate or translate relative thereto. In exemplary embodiments, the shock and vibration forces associated with travel of the mobile machine 10 may cause the first and second connection materials 44, 46 to become more intimately meshed together, thereby strengthening the removable connection therebetween. In particular, at least one of the tensile strength and the shear strength associated with this removable connection may increase as a result of and/or in response to vibrational movement of the fuel tank 12 while the fuel tank 12 is secured to the mounting frame 16.

Additionally, the flexibility of attachment between, for example, the mounting strap 18 and the mounting frame 16, and between the first and second connection materials 44, 46, reduces the forces on the adhesive used to secure the connection materials 44, 46 to the fuel tank 12 and to the various components of the fastening system 100. Moreover, the fastening systems 100 described herein do not require precise alignment of the fuel tank 12 on installation, thus significantly facilitating the fuel tank mounting process. Another advantage is that the fastening systems 100 can be detached and reattached multiple times without degrading the anti-rotation and anti-translation capabilities of the fastening system 100.

In closing, although the various embodiments have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

We claim:

1. A system for securing a fuel tank to a mobile machine, comprising:
a mounting frame connectable to the mobile machine and having a substantially rigid portion configured to support the fuel tank;
a mounting strap connected to the mounting frame and configured to secure the fuel tank to the mounting frame by extending around at least a portion of an outer surface of the fuel tank;
a first connection material connected to at least one of the mounting frame and the mounting strap; and
a second connection material configured to mesh with the first connection material thereby forming a removable hook-and-loop connection therewith, the second connection material being connectable to the outer surface of the fuel tank such that when the first connection material is meshed with the second connection material the removable connection therebetween substantially prohibits rotation of the fuel tank.

2. The system of claim 1, wherein the mounting frame includes a curved portion having a first radius of curvature substantially equal to a second radius of curvature of the outer surface of the fuel tank.

3. The system of claim 2, wherein the substantially rigid portion comprises the curved portion.

4. The system of claim 1, wherein a first end of the mounting strap is removably connectable to the mounting frame to assist in securing the fuel tank to the mounting frame and a second end of the mounting strap is fixedly connected to the mounting frame.

5. The system of claim 4, wherein at least one of the mounting frame and the first end of the mounting strap comprises a winch mechanism configured to assist in tightening the mounting strap around the outer surface of the fuel tank.

6. The system of claim 1, further including a liner disposed between the first connection material and the at least one of the mounting frame and the mounting strap.

7. The system of claim 6, wherein the liner comprises a first side fixedly connected to the at least one of the mounting frame and the mounting strap, and a second side opposite the first side, the second side being fixedly connected to the first connection material.

8. The system of claim 6, wherein the liner extends along substantially an entire length of the at least one of the mounting frame and the mounting strap.

9. The system of claim 1, wherein the first connection material comprises one of a plurality of synthetic hooks and a synthetic mesh, and wherein the second connection material comprises the other of the plurality of synthetic hooks and the synthetic mesh.

10. The system of claim 1, wherein the removable connection formed between the first and second connection materials is characterized by a tensile strength of greater than approximately 20 psi and a shear strength of greater than approximately 100 psi.

11. The system of claim 1, wherein the removable connection formed between the first and second connection materials is characterized by at least one of a tensile strength and a shear strength that increases in response to vibrational movement of the fuel tank while the fuel tank is secured to the mounting frame.

12. The system of claim 1, wherein the removable connection formed between the first and second connection materials is characterized by at least one of a tensile strength and a shear strength that is great enough to secure the fuel tank to the mounting frame while a first end of the mounting strap is disconnected from the mounting frame.

13. A system for securing a fuel tank to a mobile machine, comprising:
a mounting frame connectable to the mobile machine and having a substantially rigid portion configured to support the fuel tank;
a mounting strap having a first end removably connectable to the mounting frame and a second end fixedly connected to the mounting frame, the mounting strap configured to extend around at least a portion of an outer surface of the fuel tank when the fuel tank is supported by the mounting frame and to secure the fuel tank to the mounting frame when the first end is removably connected to the mounting frame;
a first connection material connected to at least one of the mounting frame and the mounting strap; and
a second connection material configured to mesh with the first connection material thereby forming a removable hook-and-loop connection therewith, the second connection material being connectable to the outer surface of the fuel tank such that when the first connection material is meshed with the second material the removable connection therebetween substantially prohibits rotation of the fuel tank about a longitudinal axis of the tank and translation of the tank along the longitudinal axis.

14. The system of claim 13, wherein the first connection material comprises one of a plurality of synthetic hooks and a synthetic mesh, and wherein the second connection material comprises the other of the plurality of synthetic hooks and the synthetic mesh.

15. The system of claim 13, wherein the removable connection formed between the first and second connection materials is characterized by at least one of a tensile strength and a shear strength that increases in response to vibrational movement of the fuel tank while the fuel tank is secured to the mounting frame.

16. The system of claim 13, wherein the removable connection formed between the first and second connection materials is characterized by at least one of a tensile strength and a shear strength that is great enough to secure the fuel tank to the mounting frame while the first end of the mounting strap is disconnected from the mounting frame.

17. A method of securing a fuel tank to a mobile machine, comprising disposing the fuel tank adjacent to a mounting frame connected to the mobile machine such that a first portion of an outer surface of the fuel tank abuts a corresponding curved portion of the mounting frame;
extending a mounting strap connected to the mounting frame about a second portion of the outer surface;
removably connecting a first end of the mounting strap to the mounting frame to secure the fuel tank to the mounting frame; and
forming a removable hook-and-loop connection between a first connection material connected to at least one of the mounting frame and the mounting strap, and a second connection material connected to the outer surface of the fuel tank, wherein the removable connection substantially prohibits rotation of the fuel tank.

18. The method of claim 17, wherein the removable connection formed between the first and second connection materials is characterized by at least one of a tensile strength and a shear strength that increases in response to vibrational movement of the fuel tank while the fuel tank is secured to the mounting frame.

19. The method of claim 17, wherein removably connecting the first end of the mounting strap to the mounting frame to secure the fuel tank results in formation of the removable connection between the first and second connection materials.

20. The method of claim 17, further including disposing sheet of material between the first and second connection materials prior to forming the removable connection, positioning the fuel tank at one of a desirable radial position relative to the mounting frame and a desirable axial position relative to the mounting frame, and removing the sheet of material, wherein removing the sheet of material assists in forming the removable connection.
